(19) United States
(12) Patent Application Publication
(10) Pub. No.: US 2003/0207629 A1
(43) Pub. Date: Nov. 6, 2003

(54) Highly durable, coated fabrics exhibiting hydrophobicity, oleophobicity and stain resistance and related methods

(76) Inventors: Robert T. Sobieski, Columbus, MS (US); Raymond J. Weinert JR., Macedonia, OH (US); Rodney L. Cuevas JR., Columbus, MS (US); Daniel C. Gottschalk, Columbus, MS (US)

Correspondence Address: Renner, Kenner, Greive,, Bobak, Taylor & Weber, 4th Floor, First National Tower, Akron, OH, 44308-1456, US

(21) Appl. No.: 10/136,239

(22) Filed: May 1, 2002

(51) Int. Cl. B32B 27/12; B32B 27/04

(52) U.S. Cl. 442/86; 442/91; 442/93

(57) ABSTRACT

The present invention provides a hydophobic, oleophobic and stain resistant fabric comprising a woven, non-woven, or knitted fabric substrate coated with a polymer system comprising a scrub resistant first layer at least partially penetrating the fabric substrate, the scrub resistant first layer including a polymer composition containing polymer compositional constituents similar to constituents on the fabric substrate; and a second layer comprising a fluoropolymer reacted to the surface of the scrub resistant first layer. A method for producing a hydophobic, oleophobic and stain resistant fabric including the steps of selecting a suitable fabric substrate and applying a base coating to form a scrub resistant first layer at least partially penetrating the fabric substrate; drying and curing the scrub resistant first layer; applying a fluoropolymer coating over the first layer to form a second layer; and drying and curing the second layer.

### BACKGROUND OF THE INVENTION

The present invention generally relates to water repellant and scrub resistant stain resistant fabrics and methods for making the same. More particularly, the present invention relates to coated fabrics that have properties of hydrophobicity and oleophobicity as well as stain resistance and method for its production, wherein a fabric substrate is coated with a polymeric system including a first layer forming a base coating and a second layer comprising a fluoropolymer.

Water repellency and stain resistance are important properties for many uses of textile materials, both domestic and industrial. Thus, various types of water repellant and stain resistant fabrics have been provided in the prior art. Many times, these fabrics are also produced with anti-microbial properties to further increase their durability. The term “anti-microbial” generally connotes a resistance to microbial growth and includes antibiotics, antifungal, antiviral and anti-algal agents.

While the prior art has provided water repellant and stain resistant fabrics, it has been found that the water repellency of these fabrics may not be satisfactory for given applications, and, at any rate, may be improved upon. The term “hydrophobicity” as used herein means that the fabric coating is water repellent and resists removal by washing. The term “oleophobicity” as used herein means that the fabric coating is resistant to attack and removal by oils. The two terms may be combined herein with reference to the term “repellent”. The term “stain resistant” as used herein means that the fabric coating exhibits high stain release. It has been found that the prior art, while being successful at providing fabrics with some degree of water repellency and stain resistance, does not provide fabrics having water repellant and stain resistant coatings that can survive a significant number of scrub cycles, i.e. washings.

U.S. Pat. Nos. 5,565,265, 5,747,392, 6,024,823, 6,165,920, 6,207,250, 6,251,210, assigned to High-Tex, Inc., of Farmington Hills, Mich., disclose various stain and liquid resistant and/or liquid repellant fabrics and methods for their production. These patents also provide fabrics further exhibiting anti-microbial properties. The patents disclose the use of various chemical components including copolymers, acrylics, urethanes, fluoropolymers, antimicrobial agents, crosslinking agents, catalysts, and the like, and generally teach the creation of a polymer-based coating on a fabric substrate for imparting liquid and stain resistance. However, having considered those disclosures, it has been found that the durability of the coatings produced is inadequate. Particularly, it has been found that the coatings disclosed therein are susceptible to removal from the fabric substrate after significant, yet reasonable, washing cycles.

Additionally, in much of the prior art, a fluoropolymer component is blended with other polymer components to provide a single film-forming composition to be applied to the fabric. Mixing the fluoropolymer directly with other polymer components of the coating limits the choice of polymers available for creation of the fabric coating. The present invention focuses on providing a highly durable coated fabric and method for its production. While the invention allows for flexibility in the choice of coating components, it is characterized by two separate layers, a base coating of polymer components forming a first layer and, a fluoropolymer coating forming a second layer.

### SUMMARY OF THE INVENTION

In general, the present invention provides a hydophobic, oleophobic and stain resistant fabric comprising a woven, non-woven, or knitted fabric substrate coated with a polymer system comprising a scrub resistant first layer at least partially penetrating the fabric substrate, the scrub resistant first layer including a polymer composition containing polymer compositional constituents similar to constituents on the fabric substrate; and a second layer comprising a fluoropolymer reacted to the surface of the scrub resistant first layer.

The present invention also provides a method for producing a hydophobic, oleophobic and stain resistant fabric including the steps of selecting a suitable fabric substrate; applying a base coating comprising a polymer composition containing polymer compositional constituents similar to compositional constituents on the fabric substrate, the base coat forming a first layer having functional sites and at least partially penetrating into the fabric substrate; drying and curing the first layer; applying a second polymer coating different from the base coating to the first layer comprising a fluoropolymer having functional sites; drying and curing the polymer coating; and reacting at least a portion of the functional sites of said fluoropolymer with at least a portion of the functional sites of the first layer.

The present invention also provides a method for producing a hydophobic, oleophobic and stain resistant fabric including the steps of selecting a suitable fabric substrate and applying a base coating to form a scrub resistant first layer at least partially penetrating into the fabric substrate; drying and curing the scrub resistant first layer; applying a fluoropolymer coating over the first layer to form a second layer; and drying and curing the second layer.

Due to the integration of the fluoropolymer with the first layer, the resultant two layer system coating on the fabric, exhibits durability greater than that encountered in the prior art, which typically teaches coating the fabric with a film-forming mixture of fluoropolymer and film-forming polymer, such as acrylic copolymer or urethane. That is, the present invention provides advantages over the prior art by first providing a durable first layer on the fabric to provide some stain resistance and, thereafter, at least partially reacting a fluoropolymer to that first layer to provide hydrophobicity and oleophobicity.

### DESCRIPTION OF THE DRAWINGS

FIG. 1 generally depicts a woven fabric, particularly a plain weave;

FIG. 1A is an enlarged view of the end section of yarn depicted in FIG. 1;

FIGS. 2A-2E are cross-sections of a woven fabric, taken substantially along the line 2-2 of FIG. 1, and show the proposed step-wise formation thereon of a coated fabric according to the invention having intermediate and final back coatings;

FIGS. 3A-3D are cross-sections of a woven fabric, taken substantially along the line 3-3 of FIG. 1, and show the step-wise formation thereon of a coated fabric according to the present invention having a single back coating; and

FIG. 4 provides a non-limiting exemplary schematic of the process for carrying out the present invention.

### PREFERRED EMBODIMENT FOR CARRYING OUT THE INVENTION

The purpose of this invention is to utilize processes and chemistries to provide a fabric substrate with a highly durable, scrub resistant, stain resistant and repellant coating that does not significantly affect the hand or feel of the fabric substrate. As used herein, “fabric substrate” is to cover woven, knitted and non-woven fabrics of synthetic or natural materials or blends thereof. The method consists of multiple steps, utilizing different polymer compositions having various physical characteristics and functionalities. The fabric substrate is coated in a multiple-pass process providing a multiple layered structure. In a first pass, the fabric substrate is passed through a bath containing a base composition of one or more polymeric components having available functional sites that forms a first layer or coating on the fabric substrate. At least one of the polymeric components is selected to contain chemical groups similar to at least one chemical group within the fabric substrate such that the base coating at least partially penetrates into the fabric substrate. In a subsequent pass, a fluoropolymer composition having functional sites is applied as a second layer and it reacts to the surface of the first layer coating. Particularly, the functional sites of the fluoropolymer are reacted to the functional sites of the first layer. Intermediate or final passes may be employed to provide back coatings to the fabric substrate, and antimicrobial agents may be introduced via these back coatings.

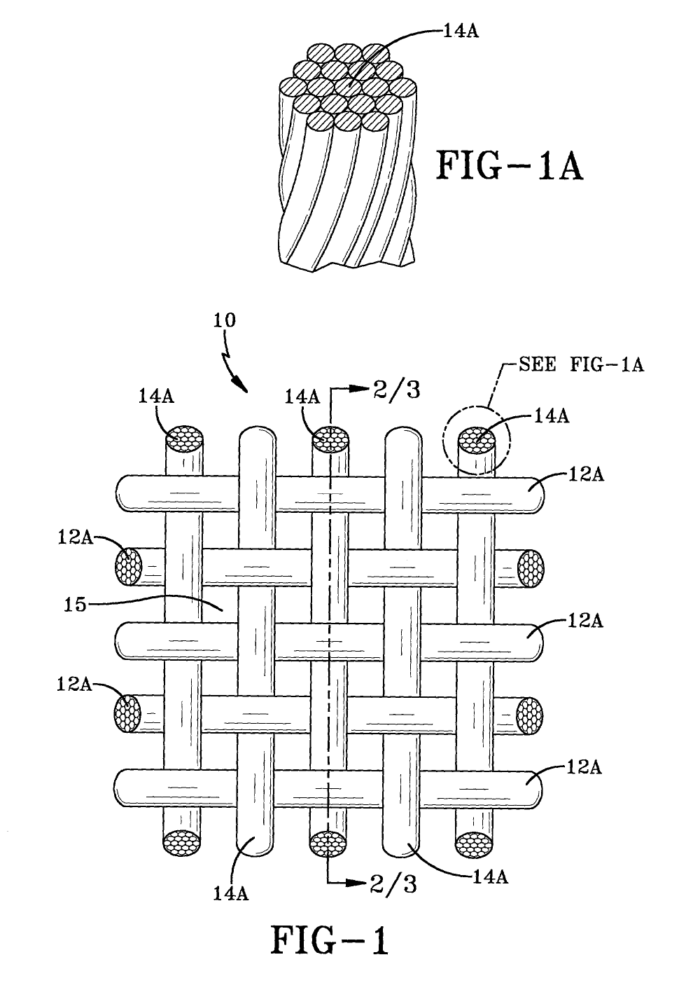

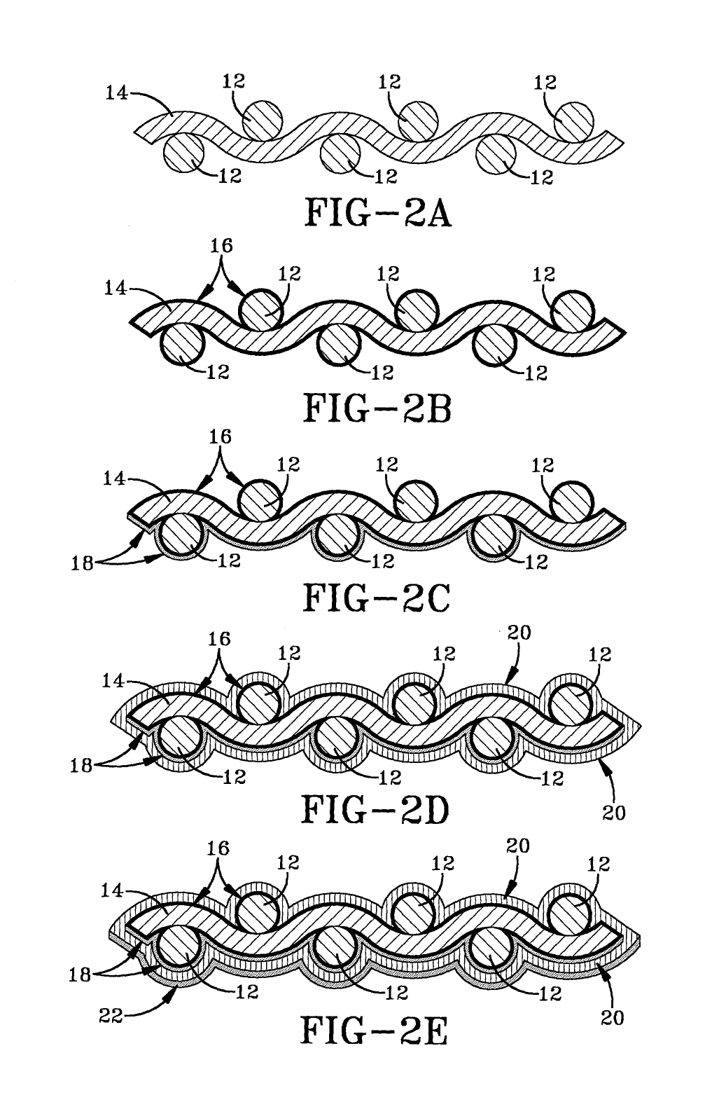

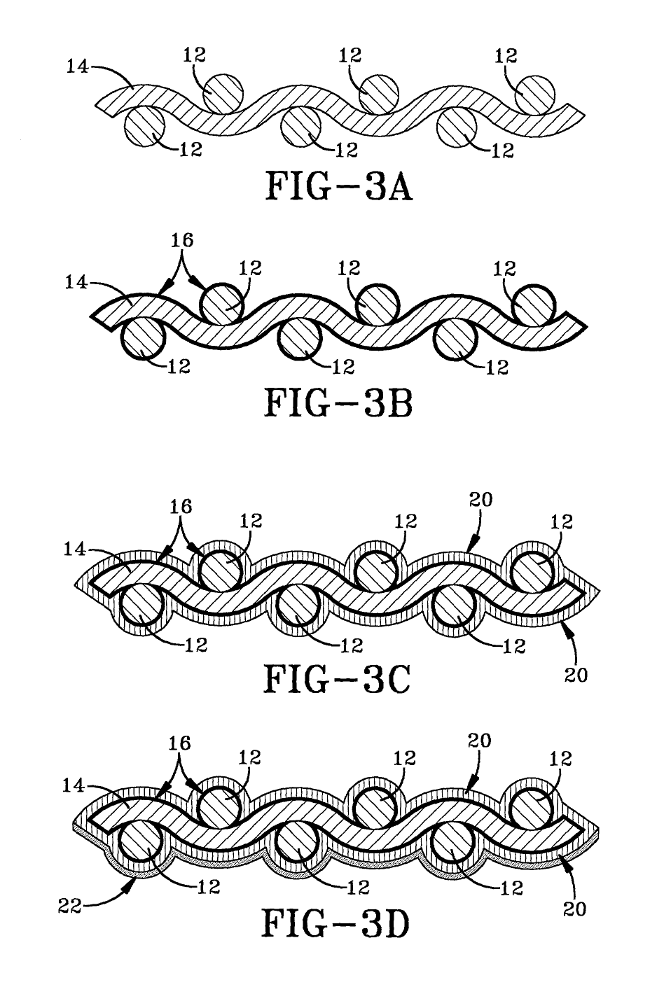

FIGS. 1-3 generally depict an uncoated plain weave fabric (FIG. 1) and plain weave fabrics coated according to the particular embodiments of the present invention (FIGS. 2 and 3). FIG. 1 simply depicts a plain weave fabric 10 having warp yarns 12 and fill yarns 14. FIG. 1 provides a cross-section reference for FIGS. 2A-2E and 3A-3D, as taken along the lines 2-2 and 3-3 of FIG. 1. In the embodiment of FIGS. 2A-2E, plain weave fabric 10 is first coated with a first layer 16 that is derived from the base coat composition. First layer 16 forms a coating on fabric 10, and is chosen according to considerations identified above and disclosed more fully hereinbelow. As depicted in FIG. 2C, fabric 10 includes an intermediate back coating 18 that is applied over first layer 16, on the back surface of fabric 10, before the application of the second layer, or fluoropolymer coating 20, as shown in FIG. 2D. Back coating 18 is termed an “intermediate” back coating because, in the embodiment of FIGS. 2A-2E, two back coatings are employed. Notably, back coatings, when employed, will be conventional back coatings as known in the art, and may contain antimicrobial agents. As depicted in FIG. 2E, a second or final back coating 22 is applied over both the first layer 16, intermediate back coating 18, and the second layer 20, again on the back surface of the fabric 10.

In FIGS. 3A-3D, a similar step-wise formation of a coated fabric is provided; however, only one back coating is employed in FIGS. 3A-3D, like parts having received like numerals, as compared with FIGS. 2A-2E. Thus, fabric 10 includes a first layer 16, a second layer 20, and a single back coating 22, and, with particular reference to FIG. 3C, it can be seen that this fabric 10 does not include an intermediate back coating 18. Of course, one could also apply the intermediate back coating 18, in lieu of the back coating 22.

It is to be appreciated that, while the multiple back coating embodiment of FIGS. 2A-2E is preferred for reasons of providing hydrostatic head, a back coating need not be applied to practice aspects of the present invention. Thus, although not depicted in the drawings, the present invention can be practiced without the application of any back coatings to the fabric, which then will receive only the first and second layers. Back coatings, when employed, may be of conventional types and may contain conventional back coating additives, such as antimicrobial agents. Due to the fact that conventional back coatings affect the pliability of the fabrics to which they are applied, it may be preferable in some applications to include either no back coating or the single back coating of FIGS. 3A-3D, to preserve the pliability of the fabric. However, in other applications, it may be advisable to employ more than one back coating, as depicted in FIGS. 2A-2E.

The compositions that are employed to provide the first layer 16 are compositions of one or more polymeric components and are chosen according to the particular fabric substrate being coated. In particular, at least one polymeric component of the first layer coating composition is chosen to contain polymer compositional constituents similar to constituents of the fabric substrate. The compositional structure of the polymer in the coating provides an affinity to the surface of the constituent groups through hydrogen bonding and/or London dispersion forces. Accordingly, a minimal surface reaction does occur, which increases the overall bonding of the first layer to the fabric substrate. If multiple polymeric components are employed for the first layer composition, while at least one polymeric component is chosen based on chemical similarity with the substrate, the other polymeric components may be chosen either based upon chemical similarity with the substrate or for shared functional sites with the at least one polymeric component that has affinity for the substrate.

With reference to FIG. 1A, separate fibers 12A and 14A, comprising the warp and fill yarns 12 and 14, respectively, have been illustrated. The base coat composition at least partially penetrates the fabric substrate, wetting the individual fibers 12A, 14A, as well as flows through the interstices 15 between the warp and fill yarns. The first layer does not occlude the interstices, as might a thick coating of wax, or plastic or rubber latex, but rather leaves it sufficiently porous for the passage of air. As the base coat composition is cured, the first layer can be likened to a fiber reinforced plastic, where the yarns and respective individual fibers comprise the fiber reinforcing the first layer, polymeric composition. It is to be understood that at least some of the separate fibers in the bundle are contacted by the base coat, while the innermost fibers may or may not be, depending upon such factors as the viscosity of the base coat and the coating application technique, including pressures.

As stated hereinabove, the fabric substrates include woven fabrics (FIGS. 1-3) as well as non-woven and knitted fabrics, both of which are not shown. The term yarn typically refers to three types of component: monofilaments; multifilament bundles of continuous strands or fibers and spun yarns of discrete fibers. Where monofilaments are employed for the manufacture of a particular fabric substrate, penetration of the base coat composition will occur at the interstices between cross-overs of the monofilament, whereas, for multifilament bundles and spun yarns of discrete fibers, penetration of the base coat will occur at the interstices between cross-overs as well as between the individual separate fibers, such as 12A and 14A. Non-woven fabrics are typically made from continuous strands, as well as discrete fibers twisted together to form continuous strands of yarn. Hence, “partial penetration” of the base coat refers to interstices as well as separate components of the yarn, where applicable.

The base coat may also partially diffuse into the fabric substrate. Partial diffusion includes reactions between functional sites on the fabric substrate and one or more components of the base coat composition. Where partial diffusion may not occur, the base coat at least penetrates the fabric substrate, as discussed hereinabove.

The first layer compositions can thus be chosen from a wide range of polymers and polymer blends. They are further selected according to their ability to provide stain resistance to the fabric substrate and for their ability to resist being removed from the fabric by scrubbing action.

The fluoropolymer compositions that are employed to give fluoropolymer coating 18 provide the fabric substrate with water and oil repellency and, to the extent that they repel water and other liquid stains, they also increase the stain resistant properties of the fabric. As with the base coat composition, the fluoropolymer includes available functional sites. After the scrub resistant coating is formed on the fabric substrate by the base coat composition, the fabric substrate is coated with the fluoropolymer, which, through available functional sites, is reacted to the first layer with suitable crosslinking agents. As mentioned, back coatings may be applied in intermediate and final passes, and preferably contain antimicrobial agents.

The fabric substrates employed in this invention may be chosen from both woven, knitted, and non-woven fabrics of natural or synthetic yarns. Non-limiting examples of suitable fabric substrates for use according to this invention include synthetic fabrics such as polyesters, nylons, rayons, thermoplastic polyolefins, and the like, and natural fabrics, such as cotton, flax, jute, and ramie, and the like. A suitable fabric substrate may also consist of a blend of natural and synthetic fabric materials. In a particularly preferred embodiment of this invention, the fabric substrate is a polyester. Also preferred are fabric substrates comprising blends of polyesters with cotton.

The base coat composition includes one or more polymeric components selected according to their affinity with the constituents of the fabric substrate. More particularly, at least one polymeric component of the base coat is chosen according to its ability to at least partially penetrate into the interstices between the yarns of the fabric substrate and, upon reacting, thereby form a durable, scrub resistant film. The wettability of the first layer on the fabric substrate will also aid in forming a satisfactory film, and, as is generally known in the art, suitable wetting agents may be employed to help the first layer wet the substrate.

The durability of the film can also be affected by mixing polymers of low glass transition temperature, such as the acrylics, with relatively hard polymers, such as the urethanes. Preferably, the base coating composition forming the first layer is a blend of an acrylic polymer with a urethane polymer.

The acrylic polymers useful for the base coating include acrylic or methacrylic terepolymer emulsions. Production of a suitable acrylic or methacrylic terepolymer emulsion could use the following types of monomeric constituents: acrylic acid 2-phenoxyethyl acrylate, ethoxylated phenol monoacrylate, lauryl acrylate, hexadecyl acrylate, stearyl acrylate, methylether monoacrylate, ethyl(meth)acrylate, ethyl(meth)acrylate, propyl(meth)acrylate, isopropyl(meth)acrylate, butyl(meth)acrylate, 2-ethyl(meth)acrylate, octyl(meth)acrylate, isobornyl(meth)acrylate, dodecyl(meth)acrylate, isobornyl acrylate, cyclohexyl(meth)acrylate, etc., 2-methoxy-ethylmethacrylate, 2-ethoxyethylmethacrylate, and 3-methoxy-propylmethacrylate, [hydroxyalkyl(meth)acrylates]: 2-hydroxethyl(meth)acrylate, 2-hydroxypropyl(meth)acrylate, 4-hydroxybutylacrylate, 6-hydroxyhexylacrylate, p-hydroxycyclohexyl(meth)acrylate, hydroxypolyethylene glycol(meth)acrylates, hydroxypolypropylene glycol(meth)acrylates and alkoxy derivatives, dipropylene glycol diacrylate Some suitable substituted (meth)acrylate compounds include (meth)acrylamide, (meth)acrylonitrile, N-methylol(meth)acrylamide, and N-alkyl(meth)acrylamides, N,N dimethyl acrylamide. Other monomers could include vinyl chloride, vinyl acetate, vinyl propionate, and vinylpyrrolidone.

As noted hereinabove, the polyurethanes are also a polymer component of the base coating composition. The preparation of polyurethanes generally proceeds in a stepwise manner as by first reacting a hydroxyl terminated polyester or polyether (reaction of polyols plus hydroxyl terminated carboxylic acid dispersants plus polyisocyanates and sometimes plus a chain extender.) Polyurethanes are converted to a polyurethane dispersion through neutralization of the polyurethane reaction usually with an amine (trimethylamine, triethylamine and dimethyl-ethanolamine) in the presence of a carboxylic acid dispersant. The neutralizing agents is at a stoichiometric ratio of 0.9 to about 1.2. Once neutralized water is added to the reaction mixture. A particularly useful polyurethane is a waterborne aliphatic polycarbonate urethane polymer manufactured by Stahl, Mass., under the trade name WF41-035. The polyisocyanates are prepared at a reaction temperature of about 40° C. to 160° C. using a catalyze and polyfunctional diisocyanates. Catalysts used include dibutyl tin dilaurate, stannous octoate, diazobicyclo(2,2,2)octane (DABCO), Zn acetyl acetonate (ACAC), and tin octoate. A suitable polyisocyanate is R(NCO)ₙ, where n is an integer of 2, 3 or 4. Examples of suitable polyisocyanates include hexamethylene diisocyanate, 2,2,4-and/or 2,4,4-trimethyl hexamethylene diisocyanate, p- or m-tetramethyl xylene diisocyanate, methylene bis(4-cyclohexyl isocyanate)(hydrogenated MDI), 4,4-methylene diphenyl isocyanate (MDI), mixtures of MDI with polymeric MDI having an average isocyanate functionality of from about 2 to about 3, 2, p- and m-phenylene diisocyanate, 2,4- and/or 2,6-toluene diisocyanate (TDI) and adducts thereof, and isophorone diisocyanate (IPDI).

The polyols can be polyether polyols, polyacetal polyols, a polyolefin polyols, organic polyols (e.g. polycarbonate polyols), or polyester polyols. The number average molecular weight for the polyols are between 400 to 15,000. Examples of the polyether polyols include polyoxypropylene or polyoxy ethylene diols and triols, poly(oxyethylene-oxypropylene)diols and triols. Examples of the polythioether polyols include glycols, dicarboxylic acids, formaldehyde, aminoalcohols or aminocarboxylic acids. Examples of the polycarbonate polyols include products obtained by reacting monomers such as diols having from 2 to 10 carbon atoms such as 1,3-propanediol, 1,4-butanediol, 1,6-hexanediol, diethylene glycol or tetraethylene glycol with diaryl carbonates having from 13 to 20 carbon atoms, for example diphenyl carbonate, or with phosgene.

The base coat composition can also include surfactants for the dispersion of the polymers such as the hydroxyl terminated carboxylic acid dispersants which are an organic compound which contains one or more carboxyl groups and two or more hydroxyl groups.(e.g. 2,2-dimethylol propionic acid). Useful compounds include the fumarate polyether glycols described in U.S. Pat. No. 4,460,738, the subject matter of which is incorporated herein by reference. Other useful carboxyl-containing compounds include aminocarboxylic acids, for example lysine, cystine and 3,5-diaminobenzoic acid.

The first layer composition may also include a number of optional additives commonly employed in the art. These optional additives include wetting agents, coalescing agents, crosslinking agents, and other curatives, as mentioned above; non-rewetters, which serve to reduce the surface tension of the coating composition to allow for proper wetting of the fabric substrate; catalysts, which may be employed to facilitate the activation of crosslinking agents and thereby aid in the formation of the base film through partial crosslinking or coalescence of the first layer composition; defoamers, which may be employed to suppress excessive foaming of the base composition; and other additives generally employed in this field. These additives would be present in conventional amounts, chosen so as to not have a negative impact on the properties of the base coat composition.

The base coat composition is also selected to have available functional sites, such as hydroxyl or carboxyl groups. These functional sites provide a means for forming the first layer composition into a durable, scrub resistant film on the fabric substrate, through partial crosslinking, and, additionally, provide functional sites for binding a fluoropolymer to the base film formed by the first layer composition, as will be explained more fully hereinbelow.

In particular embodiments of this invention, the fabric is a polyester, and the film-forming base composition comprises a water-borne polycarbonate urethane with pendent carboxyl groups and a carboxylated acrylic copolymer in amounts of from about 5 to about 95 parts by weight of the urethane with from about 95 parts to about 5 parts by weight of the acrylic copolymer, to total 100 parts by weight. Preferably, the composition comprises from about 65 dry to about 75 dry parts by weight of the urethane with from about 35 dry parts to about 25 dry parts by weight of the acrylic copolymer. The chemical structure of the resulting coating composition has an affinity for the surface of the substrate which, in the presence of reactive crosslinking species, could bind the base coating to the substrate. In addition to the two polymer components, the base composition also comprises an amine oxide (non-rewetter) in amounts from about 5 to about 10 php (parts per hundred polymer). Preferably, the amine oxide is included at from about 6 to about 8 php. The base composition also includes tri-functional azeridine (crosslinking agent) at up to about 5 php, preferably, from about 0.5 to about 1.5 php.

After the base film is formed, an intermediate back coating (e.g. back coating 22, FIG. 3) may optionally be applied to the fabric substrate to give hydrostatic head and/or protect from bacterial and bacterial by-product migration. This optional back coating is a conventional coating as known in the art, and is applied only to the rear or back face of the fabric. The back coating may contain an antimicrobial agent, which serves to preserve the structural integrity of the fabric substrate against deterioration by bacteria, fungus, algae, and other microbial organisms. If this back coating is employed, it is fully dried, as known in the art, before application of the fluoropolymer in a subsequent pass.

The composition of the back coating is generally based upon conventional acrylic latices as are well known in the industry. A useful back coating is Performax 3714, a proprietary acrylic formulation supplied by Noveon (Ohio, USA). A formulation for a base coating includes 45 to 50% soft acrylic water based emulsion; 22-27% filler, such as calcium carbonate; 10-12% thickener e.g., an alkali swellable material; 1-3% crosslinker, such as a urea formaldehyde; 0.5-1% defoamer; 1-2% surfactant and 1-2% amine.

After forming the first layer from the base coat composition and, optionally, applying a back coating, the fabric substrate is passed through a bath containing a fluoropolymer composition. The fluoropolymer is selected based upon its ability to react with the available function sites on the first layer and form a second layer.

Generally, any commercially available repellant fluoropolymer may be employed according to this invention, with the proviso that the fluoropolymer is chosen to have functional sites that can be crosslinked to functional sites remaining in the first layer. The fluoropolymers that may be used in this application are well known to those of ordinary skill in the art and include all of the fluorochemical textile treating agents. In particular, any of the fluoropolymer/fluorochemical textile treating agents disclosed in U.S. Pat. Nos. 5,565,265; 5,747,392; 6,024,823; 6,165,920; 6,207,230 and 6,252,210 can be employed, the subject matter of which is incorporated herein by reference. Significantly, however, the present invention differentiates from these patents in that the fluoropolymers comprising the second layer are not mixed, blended and applied in a composition including any acrylic or urethane polymers and, the fluoropolymers comprising the second layer are only applied over a first layer, which, in a preferred embodiment, comprises a blend of acrylic and urethane polymers, said first layer being cured beforehand.

Useful fluoropolymers for practice of the present invention and commercially available are Lumiflon FE-440, a fluorinated resin from Zeneca Resins; Scotchguard brand from 3M; Nuva, from Clariant; Sequapel GFC; Unidyne and Daikin Zeffle SE, from Daikin. Sequapel GFC is available from Omonva Solutions, Inc., Akron, Ohio and is particularly useful as the fluoropolymer.

Alternative materials may include fluorinated oxetane co- or tere-polymers prepared by OMNOVA Solutions, as described in U.S. Pats. No. 5,650,483; 5,668,250; 5,688,251; and 5,663,289, the subject matter of which is incorporated herein by reference. Four carbon fluorocarbon polymers and lower R-F groups are preferable as they have shown no bioaccumulation upon testing. Perfluorocarbon moeities of up to four carbon atoms in length are thus particularly useful. Alternatively, acrylic, polyether and epoxy based materials can be made utilizing R-F groups based on heptafluorobutyl, perfluoropropyl, and trifluoro ethyl pendant groups that are non-bioacumulative.

In addition to the fluoropolymer component, the fluoropolymer composition also comprises a non-rewetter and crosslinking agent. The non-rewetter serves to reduce surface tension to promote wetting and surface coverage, while the crosslinking agent serves to react the fluoropolymer to the first layer composition.

Those of ordinary skill in the art should be readily able to select an appropriate fluoropolymer, based upon the available functional sites of the base film. The following non-limiting examples are also provided as a general guide for the selection of appropriate fluoropolymers. For example, if the first layer provides hydroxyl functionalities, the fluoropolymer has functional moieties that will react with suitable hydroxy-reactive crosslinking agents, such as melamine formaldehyde. This would be employed to react the fluoropolymer to the first layer. Aziridine could be used if the reactive moieties should change.

After the application and crosslinking/drying of the fluoropolymer layer, a second back coating (as at back coating 22, FIG. 2E), which may also contain an antimicrobial agent, as with the first optional intermediate back coating, may be applied. This optional back coating would also take conventional forms and would be applied in a conventional manner. The composition of the optional back coat includes those described hereinabove, although the specific second coating may be the same as or different from the first back coat.

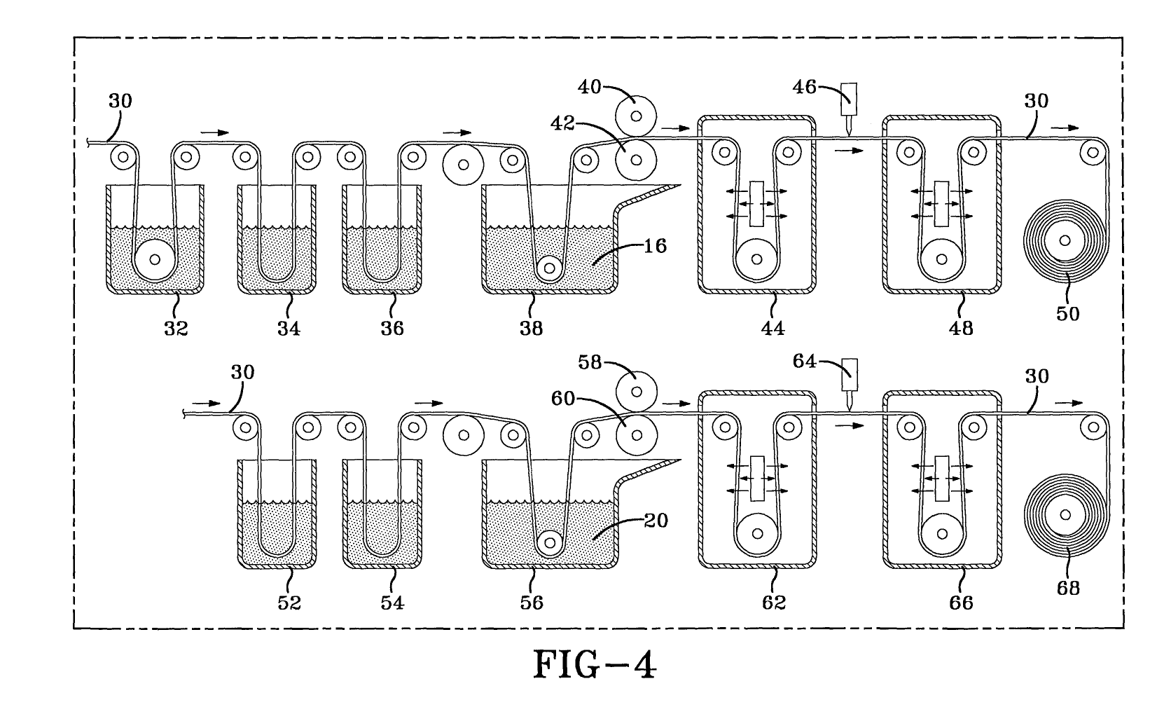

Before applying the first layer, the fabric substrate is preferably cleaned by scouring the fabric to eliminate any residual sizing agents left from fabric production that might cause the fabric to be hydroscopic. With respect to FIG. 4, the fabric 10 is let off from a suitable source (not shown) and is passed through a scouring tank 32, containing water and a strong detergent, such as trisodium phosphate, after which it passes through first and second wash tanks 34 and 36, containing water. Once cleaned, the first coating is applied to the fabric substrate. Immediately following washing, the fabric is next fed into a first dip coating tank 38, for application of the base coat composition 16. Thus, both sides are coated in one pass, and the fabric carrying the wet base composition is passed between opposed rolls 40, 42, or doctor blades (not shown) to apply pressure to the fabric substrate 10 after wet pick-up of the base coat composition and thereby help to ensure that the interstices within the fabric substrate 10 are also coated. The rolls 40, 42 may also help to remove any excess amount of the base coat composition picked-up on the fabric 10 during its passage through the bath 16.

Next, the wetted fabric 10 is passed through a drying oven 44 where the base coat is dried via removal of water and other volatiles at a temperature and for a residence time sufficient to at least partially cure the first layer. If a back coating is to be employed, such as back coating 18 of FIG. 2C, it may be applied by a knife blade 46, after drying of the first layer. The substrate carrying the first layer and optional back coating is then passed through the curing stage 48, where additional heat is applied to cure the first layer and the back coating. After drying and curing, the fabric substrate 10, now coated with a first layer 16 and, optionally, a back coating 18, is collected on a take-up roll 50.

For the method depicted in FIG. 4, the fabric 10 is first taken up on roll 50 where it is then transported to the next stage, as will be described now. Take-up roll 50 is an optional, non-limiting step in the method, as the fabric 10 could as readily have been continuously directed through subsequent stages of the apparatus. Either way, the fabric 10 is next subjected to additional washings by passing through wash tanks 52 and 54. Immediately following washing, the fabric is next fed into a second dip coating tank 56, for application of the fluoropolymer composition 20. Again, both sides are coated in one pass, and the fabric carrying the wet base composition is passed between opposed rolls 58, 60, or doctor blades (not shown) to apply pressure to the fabric substrate 10 after wet pick-up of the fluoropolymer composition and thereby help to ensure that the interstices within the fabric substrate 10 are also coated. The rolls 58, 60 may also help to remove any excess amount of the fluoropolymer composition picked-up on the fabric 10 during its passage through the bath 20.

Next, the wetted fabric 10 is passed through a second drying oven 62 where the fluoropolymer composition is dried via removal of water and other volatiles at a temperature and for a residence time sufficient to at least partially cure the second layer. If a back coating is to be employed, such as back coating 22 of FIG. 2E, it may be applied by a knife blade 64, after drying of the first layer. The substrate carrying the second layer and optional back coating is then passed through the second curing stage 66, where additional heat is applied to cure the second layer and the back coating. After drying and curing, the fabric substrate 10, now coated with first layer and second layers 16 and 20, and optional back coatings 18 and 22, is collected on a final take-up roll 68.

For practice of an alternate method, where only one back coating layer is applied, as in FIGS. 3A-3D, only one back coating 18 or 22 is applied, with the understanding that the fabric passes from drying to curing of one of the layers without application of the back coating. The present invention also contemplates coated fabrics containing only first and second layers of polymeric materials as described herein, and no back coatings. It is also to be appreciated that although the apparatus and method has been described schematically with reference to tanks and rollers that guide the fabric through the compositions as well as through drying and curing ovens or stages, that alternative equipment could be substituted.

What characterizes the method of this invention over the prior art is the application of a first layer of polymers, which layer is dried and cured prior to the application of a second layer of polymer composition different from the first. Once the fabric 10 containing the first layer and optional back coating leaves the first curing oven 48, these layers are not removed in the second stage washing tanks 52 and 54, prior to application of the fluoropolymer layer. Second stage washings merely remove excess surfactants, if any.

The focus in applying the first layer is on the dry pick-up of the base film onto the fabric substrate. As those of ordinary skill in the art will readily appreciate, the weight percent of bath solids may vary to a large degree. For instance, if the bath contains a high percentage of solids, a lower wet pick-up is required to realize a dry pick-up that is satisfactory for forming the durable, scrub resistant base film, while, if the bath contains a lower percentage of solids, a higher wet pick-up is required to realize a satisfactory dry pick-up.

While it should be appreciated that the dry pick-up on the fabric substrate may vary according to the desired properties for the resultant coated fabric, the dry weight of the first layer picked up in this pass may range from about 1 to about 10 percent of the weight of the fabric substrate. Preferably, the dry weight ranges from about 4 to 6 percent of the fabric weight.

Generally, when considering the dry pick-up on the fabric, for abrasive and stain resistant properties, a larger dry pick-up is desired. However, it will be appreciated that aesthetics will be negatively affected as the amount of dry pick-up increases. The greatest amount of practical dry pick-up, with the highest level of stain and non-abrasive polymer constituent, can be arrived at experimentally.

In a particular embodiment of this invention, the fabric substrate is a polyester, and the base coat composition is a carboxylated acrylic copolymer and polycarbonate urethane polymer blend. More particularly, the acrylic copolymer is Hycar T-138(Noveon, Ohio, U.S.A.), and has carboxyl and sulfonate groups that make it possible to crosslink with itself or other polymer systems such as acrylics, urethanes, and/or fluoropolymers sharing the same type of functionality. This acrylic copolymer has a low glass transition temperature (T_{g}) of about −20° C., which permits the blending of this acrylic copolymer with a relatively hard polymer, while maintaining the hand and feel of the fabric being coated. Thus, this acrylic copolymer, in the preferred embodiment, is blended with a urethane latex, namely WF41-035 (Stahl, Mass., U.S.A.), which contains pendant carboxyl groups and has a Sward hardness of about 50.

The base coat composition bath is made up of WF41-035 and Hycar T-138, blended at from 10 to 50%_{dry} acrylic polymer to from 90 to 50%_{dry} urethane. The bath also contains a small concentration, up to about 5 php, of trifunctional aziridine, a crosslinking agent, and from about 2 to about 6 php of amine oxide, a non-re-wetter. The polyester fabric of this preferred embodiment is passed through this bath to achieve a wet pick-up of from about 40 to about 50%, correlating to a dry pick-up in the area of about 2%.

The acrylic copolymer and urethane blend that forms the major portion of the base coat composition is caused to partially crosslink through the aziridine crosslinking agent, which forms a minor portion of the base coat bath. Notably, when crosslinking is employed to form the first layer, the composition is only partially reacted so that available functional sites are still present for binding with a fluoropolymer that is subsequently applied to the fabric substrate as described hereinbelow.

The fluoropolymer of this embodiment is Sequapel GFC (Omnova Solutions, Inc., Ohio, U.S.A.), which is a fluorinated acrylate having active hydrogen (carboxyl) groups within the polymer matrix. These groups allow the fluoropolymer to be bound to the blend of acrylic copolymer and urethane polymer that makes up the first layer due to the fact that the first layer, as mentioned above, contains active carboxyl groups. The fluoropolymer is the major solid component, while aziridine is present at from about 0.5 to about 1.5 php, and amine oxide is present from about 6 to about 8 php. The polyester fabric of this preferred embodiment is passed through the fluoropolymer composition bath to achieve a dry pick-up of from about 0.25 to about 15 percent by weight.

The back coating material of acrylic material was applied twice, as two coatings, once after the first layer was applied and partially cured and once after the second layer was applied and partially cured. The composition is based on a soft water based emulsion, containing filler, thickener, a urea-formaldehyde crosslinker, defoamer and wetting agent.

### EXPERIMENTAL

### Example A

A polyester Jacquard was coated according to the present invention. First, the polyester fabric was passed through a base coat composition bath having the following chemical make-up:

| Reagent | Amount/100# batch | Activity |
|---|---|---|
| Urethane (WF41-035) | 8# | 35% |
| Acrylic Copolymer | 2.6# | 48% |
| (T-138) | | |
| Amine Oxide | 0.01# | 100% |
| Azeridine | 0.04# | 100% |
| H₂O | 89.5# | n/a |

The acrylic copolymer, Hycar T-138, had a glass temperature transition of −20° C., which permitted the blending of this acrylic copolymer, at low concentration, with an extremely hard polymer, namely, the urethane latex, WF 41-035, and, yet, the pliability of the resultant fabric was maintained. The acrylic copolymer had active hydrogen groups, carboxyl and sulfonate, making it possible to crosslink this acrylic copolymer with itself or other polymer systems sharing the same type of functionality. The base coat composition bath had a 4 percent total solids concentration, inclusive of the small concentration of trifunctional aziridine (a crosslinker) and amine oxide (a non-rewetter). The wet pick-up in this first layer pass was 50 percent, yielding a dry pick-up of 2 percent.

The base coat composition was caused to form a first layer by passing the coated fabric over heating cans at 175° F. to cure the composition. The acrylic copolymer/urethane coating provides stain resistance, and was chosen based upon its affinity and adhesion with the polyester fabric. The softer acrylic latex coalesces and crosslinks with the extremely hard polycarbonate urethane and provides a first layer with appreciable strength, which would not be the case if the fluoropolymer were present in this composition.

The treated fabric was then back coated with a conventional acrylic latex at a wet pick-up of 47 percent and dry pick-up of 22 percent, and was thereafter completely dried and cured in an oven at 350° F.

Next, the fabric was passed through a fluoropolymer composition bath so that the fluoropolymer could be incorporated on to the first layer that was formed in the first pass. The fluoropolymer composition bath was made up as follows:

| Reagent | Amount/100# batch | Activity |
|---|---|---|
| Fluoropolymer | 10# | 30% |
| (Sequapel GFC) | | |
| Amine Oxide | 0.03# | 100% |
| Azeridine | 0.2# | 100% |
| Water | 89.8# | n/a |

The wet pick-up of the fluoropolymer was 50 percent, corresponding to a dry pick-up of 1.5 percent. The fluoropolymer was reacted to the surface of the acrylic copolymer/urethane first layer through the aziridine crosslinking agent, upon passing the coated fabric over heating cans at 175° F. The fluoropolymer was applied as a second coat, and it repels water as well as dirt and grime materials. It is an extremely durable coating, and, if it is worn away or penetrated, the first layer continues to provide stain resistance.

The treated fabric was back coated a second time with the conventional acrylic latex at a wet pick-up of 47 percent and dry pick-up of 22 percent, and was thereafter completely dried and cured in an oven at 350° F.

The following comparative examples are provided to show that the sequential application of a first layer composition and a fluoropolymer is not the equivalent of employing a single coating comprising all of the components.

### Example B

In this example, the same chemical compositions were employed as that of Example A. However, in this example, a single coating operation was employed. That is, all of the chemical compositions were blended together as a single composition bath and then applied to the polyester fabric in one pass. The ratio of acrylic copolymer/urethane to fluoropolymer was 17/40/43, as was the ratio in Example A, but in two separate coatings. The same dry pick-up as in Example A was also employed, i.e, 3.5% dry pick-up.

### Example C

This is a single padding operation, as that described in the Hi-Tex patents, hereinabove. Here, Sequapel fluoropolymer was the only coating composition, and a 4.5% dry pick-up was employed.

The coated fabrics of Examples A, B and C were cut into four inch by fourteen inch strips and laminated onto glass with a two-sided adhesive tape, such that no back coating chemistry would interfere with the cleanability and durability evaluations to be made. These samples were then stained with black shoe polish (liquid), betedine, blue ball point pen (ink), black permanent marker and mustard, and were allowed to sit for a period of one hour.

As these stains were applied, the physical characteristics of the samples were documented, such as stain repulsion and/or wettability. After each staining cycle, the samples were flushed with a liberal amount of water, placed in a BYK Gardner scrub apparatus and scrubbed aggressively, for fifty scrub cycles with a water-based cleaner, particularly, Formula 409™. A single scrub cycle includes a forward and return pass of the brush. These samples were then flushed again with water, and stain appearance and fabric defects were documented before the samples were scrubbed for an additional fifty cycles with 100 percent isopropyl alcohol (IPA), a solvent-based cleaner. Stain appearance and fabric defects after treatment with isopropyl alcohol were also documented. After both solvent/cleaners were evaluated (100 cycles) the samples were washed again, dried and re-stained of marked for the next 100 cycles and this regime was repeated two more times. The following tables depict the findings of the comparisons.

| STAIN RESULT RATING: | STAIN CHARACTERISTIC: |
|---|---|
| 5 = Negligible or no stain | R - Repels |
| 4 = Slightly stained | W - Stain Wetting |
| 3 = Noticeably stained | |
| 2 = Considerably stained | |
| 1 = Heavily stained | |

For wetting stains such as shoe polish, betedine and mustard, stain characteristics were evaluated. Non-wetting stains, such as blue ink and black marker could not be evaluated for stain characteristics.

TABLE I
Coated Fabrics Exposed to Shoe Polish

| Cycles | 100 | | 200 | | 300 | | 400 | |
|---|---|---|---|---|---|---|---|---|
| Sample | Shoe Polish | | Shoe Polish | | Shoe Polish | | Shoe Polish | |
| Formula | Staining | | Staining | | Staining | | Staining | |
| 409 | Characteristic | | Characteristic | | Characteristic | | Characteristic | |
| A | 5 | R | 5 | R | 5 | R | 4 | W |
| B | 5 | R | 5 | W | 1 | W | 1 | W |
| C | 2 | W | 2 | W | 1 | W | 1 | W |
| IPA | | | | | | | | |
| A | 5 | R | 5 | R | 5 | R | 5 | R |
| B | 5 | R | 3 | W | 2 | W | 2 | W |
| C | 5 | W | 4 | W | 1 | W | 1 | W |

As is evident from Table I, stain ratings value and resistance were greatest for Sample A, representing the present invention. For Sample B, where all polymeric components of Sample A were combined and applied in a single coating, stain resistance failed after the first 200 scrub cycles and stain rating indicated heavy staining after the first 300 scrub cycles. For Sample C, where only a fluoropolymer coating was applied, stain wetting occurred within the first 100 scrub cycles and staining was considerable. For both Samples B and C, stain resistance was better in IPA than in the detergent; however, stain wetting quickly occurred after only 100 scrub cycles.

TABLE II
Coated Fabrics Exposed to Betedine

| Cycles | 100 | | 200 | | 300 | | 400 | |
|---|---|---|---|---|---|---|---|---|
| Sample | Betedine | | Betedine | | Betedine | | Betedine | |
| Formula | Staining | | Staining | | Staining | | Staining | |
| 409 | Characteristic | | Characteristic | | Characteristic | | Characteristic | |
| A | 5 | R | 5 | R | 5 | R | 5 | R |
| B | 4 | R | 4 | W | 1 | W | 1 | W |
| C | 4 | W | 4 | W | 3 | W | 2 | W |
| IPA | | | | | | | | |
| A | 5 | R | 5 | R | 5 | R | 5 | R |
| B | 5 | R | 3 | W | 2 | W | 1 | W |
| C | 5 | W | 4 | W | 4 | W | 3 | W |

As is evident from Table II, stain ratings value and resistance were greatest for Sample A, representing the present invention. For Sample B, where all polymeric components of Sample A were combined and applied in a single coating, stain resistance failed after the first 300 scrub cycles and heavy staining occurred after the first 200 scrub cycles. Considering Sample C, where only a fluoropolymer coating was applied, stain wetting was marginally better than for Sample B while staining was considerable. None of the results were as good as for Sample A. For both Samples B and C, stain resistance was better in IPA than in the detergent; however, stain wetting quickly occurred after only 100 scrub cycles.

TABLE III
Coated Fabrics Exposed to Blue Ink

| Cycles | 100 | 200 | 300 | 400 |
|---|---|---|---|---|
| Sample | Blue Ink | Blue Ink | Blue Ink | Blue Ink |
| Formula | Staining | Staining | Staining | Staining |
| 409 | Characteristic | Characteristic | Characteristic | Characteristic |
| A | 3 | 3 | 5 | 4 |
| B | 5 | 5 | 2 | 1 |
| C | 1 | 1 | 1 | 1 |
| IPA | | | | |
| A | 5 | 5 | 5 | 5 |
| B | 5 | 2 | 2 | 2 |
| C | 5 | 3 | 1 | 1 |

As is evident from Table III, stain ratings began slightly lower for Sample A than for Sample B, where all polymeric components of Sample A were combined and applied in a single coating, but Sample B failed thereafter. For Sample C, where only a fluoropolymer coating was applied, staining was generally heavy. Stain wetting was not determined. For Sample C, stain resistance was better in IPA than in the detergent; however, the fabric began failing after 100 scrub cycles.

TABLE IV
Coated Fabrics Exposed to Black Marker

| Cycles | 100 | 200 | 300 | 400 |
|---|---|---|---|---|
| Sample | Black | Black | Black | Black |
| | Marker | Marker | Marker | Marker |
| Formula | Staining | Staining | Staining | Staining |
| 409 | Characteristic | Characteristic | Characteristic | Characteristic |
| A | 2 | 2 | 3 | 3 |
| B | 4 | 4 | 1 | 1 |
| C | 1 | 1 | 1 | 1 |
| IPA | | | | |
| A | 5 | 4 | 4 | 4 |
| B | 4 | 1 | 2 | 2 |
| C | 5 | 2 | 1 | 1 |

As is evident from Table IV, stain ratings began lower for Sample A than for Sample B, where all polymeric components of Sample A were combined and applied in a single coating, but Sample B failed thereafter. For Sample C, where only a fluoropolymer coating was applied, staining was generally heavy. Stain wetting was not determined. For Sample C, stain resistance was better in IPA than in the detergent, but began failing after only 100 scrub cycles.

TABLE V
Coated Fabrics Exposed to Mustard

| Cycles | 100 | | 200 | | 300 | | 400 | |
|---|---|---|---|---|---|---|---|---|
| Sample | Mustard | | Mustard | | Mustard | | Mustard | |
| Formula | Staining | | Staining | | Staining | | Staining | |
| 409 | Characteristic | | Characteristic | | Characteristic | | Characteristic | |
| A | 5 | R | 5 | R | 5 | R | 5 | R |
| B | 5 | R | 5 | W | 3 | W | 2 | W |
| C | 4 | W | 4 | W | 4 | W | 4 | W |
| IPA | | | | | | | | |
| A | 5 | R | 5 | R | 5 | R | 5 | R |
| B | 5 | R | 5 | W | 4 | W | 4 | W |
| C | 5 | W | 5 | W | 4 | W | 4 | W |

As is evident from Table V, stain ratings value and resistance were greatest for Sample A, representing the present invention. For Sample B, where all polymeric components of Sample A were combined and applied in a single coating, stain resistance failed after the first 200 scrub cycles and stain rating indicated heavy staining after the first 400 scrub cycles. For Sample C, where only a fluoropolymer coating was applied, stain wetting occurred within the first 100 scrub cycles although staining was comparable to Sample B. For both Samples B and C, stain resistance was better in IPA than in the detergent; however, stain wetting quickly occurred after only 100 to 200 scrub cycles.

TABLE VI
Fabric Appearance after Scrubbing

| | | | | |
|---|---|---|---|---|
| Cycles | 100 | 200 | 300 | 400 |
| Sample | Fabric Look | Fabric Look | Fabric Look | Fabric Look |
| Formula | Staining | Staining | Staining | Staining |
| 409 | Characteristic | characteristic | Characteristic | Characteristic |
| A | Good | Good | Good | Good |
| B | Good | Good | Poor | Poor |
| C | Good | Good | Fair | Fair |
| IPA | | | | |
| A | Good | Good | Good | Good |
| B | Good | Fair | Poor | Poor |
| C | Good | Good | Poor | Poor |

As is evident from Table VI, fabric appearance was good for Sample A, throughout the entire scrub cycles while Samples B and C eventually became poor.

In light of the foregoing, it should thus be evident that the present invention, providing a coated fabric and method, substantially improves the art. Although the invention has been exemplified in Example A, it is to be appreciated that this is a non-limiting example. Accordingly, based upon the disclosure herein of polymeric components for the coating compositions that form the first and second layers on the fabric, those skilled in the art should be able to select alternative acrylic and urethane polymers as well as fluoropolymers with which to practice the invention, as well as suitable crosslinking agents, various surfactants and other components. Moreover, practice of the present invention is not limited to a particular fabric substrate.

While, in accordance with the patent statutes, only the preferred embodiments of the present invention have been described in detail hereinabove, the present invention is not to be limited thereto or thereby. Rather, the scope of the invention shall include all modifications and variations that fall within the scope of the attached claims.

What is claimed is:

1. A hydophobic, oleophobic and stain resistant fabric comprising:
a fabric substrate coated with a polymer system comprising:
a scrub resistant first layer at least partially penetrating said fabric substrate, said scrub resistant first layer including a polymer composition containing polymer compositional constituents similar to constituents on said fabric substrate; and
a second layer comprising a fluoropolymer reacted to the surface of said scrub resistant first layer.

2. The fabric of claim 1, wherein said fabric substrate is selected from the group consisting of synthetic fabrics selected from the group consisting of polyesters, nylons, rayons, thermoplastic polyolefins and mixtures thereof and natural fabrics, selected from the group consisting of cotton, flax, jute, and ramie, mixtures thereof and mixtures of synthetics and natural fabrics.

3. The fabric of claim 2, wherein said fabric substrate is selected from a polyester fabric substrate and a polyester-cotton blend fabric substrate.

4. The fabric of claim 1, wherein said fabric substrate is a polyester, and the polymers of said polymer composition consist essentially of an acrylic polymer with a urethane polymer.

5. The fabric of claim 4, wherein said acrylic polymer is selected from the group consisting of include acrylic or methacrylic terepolymer emulsions prepared from monomeric constituents selected from the group consisting of acrylic acid 2-phenoxyethyl acrylate, ethoxylated phenol monoacrylate, lauryl acrylate, hexadecyl acrylate, stearyl acrylate, methylether monoacrylate, ethyl(meth)acrylate, ethyl(meth)acrylate, propyl(meth)acrylate, isopropyl(meth)acrylate, butyl(meth)acrylate, 2-ethyl(meth)acrylate, octyl(meth)acrylate, isobornyl(meth)acrylate, dodecyl(meth)acrylate, isobornyl acrylate, cyclohexyl(meth)acrylate, 2-methoxy-ethylmethacrylate, 2-ethoxyethylmethacrylate, and 3-methoxy-propylmethacrylate, 2-hydroxethyl(meth)acrylate, 2-hydroxypropyl(meth)acrylate, 4-hydroxybutylacrylate, 6-hydroxyhexylacrylate, p-hydroxycyclohexyl(meth)acrylate, hydroxypolyethylene glycol(meth)acrylates, hydroxypolypropylene glycol(meth)acrylates and alkoxy derivatives, dipropylene glycol diacrylate; substituted (meth)acrylate compounds; vinyl chloride, vinyl acetate, vinyl propionate, and vinylpyrrolidone and mixtures thereof.

6. The fabric of claim 4, wherein said first layer includes a water-borne polycarbonate urethane with pendent carboxyl groups and a carboxylated acrylic copolymer.

7. The fabric of claim 6, wherein said water-borne polycarbonate urethane is present in an amount of from about 5 to about 95 parts by weight, and said acrylic copolymer is present in an amount of from about 95 parts to about 5 parts by weight.

8. The fabric of claim 1, wherein said second layer comprises a polymer selected from the group consisting of fluoropolymer textile treating agents.

9. The fabric of claim 8, wherein said fluoropolymer textile treating agents are selected from the group, consisting of perfluorocarbon moeities up to four carbon atoms in length.

10. The fabric of claim 1, further comprising at least one back coating, applied to said first layer.

11. The fabric of claim 1, further comprising at least one back coating, applied to said second layer.

12. The fabric of claim 1, further comprising a first back coating, applied to said first layer and a second back coating, applied to second layer.

13. A method for producing a hydrophobic, oleophobic and stain resistant fabric including the steps of
selecting a suitable fabric substrate;
applying a base coating comprising a polymer composition containing polymer compositional constituents similar to compositional constituents on said fabric substrate, said base coat forming a first layer having functional sites and at least partially penetrating said fabric substrate;
drying and curing said first layer;
applying a second polymer coating different from said base coating to said first layer comprising a fluoropolymer having functional sites;
drying and curing said second polymer coating; and
reacting at least a portion of the functional sites of said fluoropolymer with at least a portion of the functional sites of said first layer.

14. The method of claim 13, comprising the further step of applying at least one back coating to said first layer.

15. The method of claim 13, comprising the further step of applying at least one back coating, applied to said second layer.

16. The method of claim 13, comprising the further steps of applying a first back coating to said first layer and applying a second back coating to said second layer.

17. The method of claim 13, wherein said step of applying a base coating includes forming a polymer composition consisting essentially of an acrylic polymer with a urethane polymer.

18. The method of claim 17, wherein said acrylic polymer is formed from monomers selected from the group consisting of include acrylic or methacrylic terepolymer emulsions prepared from monomeric constituents selected from the group consisting of acrylic acid 2-phenoxyethyl acrylate, ethoxylated phenol monoacrylate, lauryl acrylate, hexadecyl acrylate, stearyl acrylate, methylether monoacrylate, ethyl(meth)acrylate, ethyl(meth)acrylate, propyl(meth)acrylate, isopropyl(meth)acrylate, butyl(meth)acrylate, 2-ethyl(meth)acrylate, octyl(meth)acrylate, isobornyl(meth)acrylate, dodecyl(meth)acrylate, isobornyl acrylate, cyclohexyl(meth)acrylate, 2-methoxy-ethylmethacrylate, 2-ethoxyethylmethacrylate, and 3-methoxy-propylmethacrylate, 2-hydroxethyl(meth)acrylate, 2-hydroxypropyl(meth)acrylate, 4-hydroxybutylacrylate, 6-hydroxyhexylacrylate, p-hydroxycyclohexyl(meth)acrylate, hydroxypolyethylene glycol(meth)acrylates, hydroxypolypropylene glycol(meth)acrylates and alkoxy derivatives, dipropylene glycol diacrylate; substituted (meth)acrylate compounds; vinyl chloride, vinyl acetate, vinyl propionate, and vinylpyrrolidone and mixtures thereof.

19. The method of claim 17, wherein said base coating includes a water-borne polycarbonate urethane with pendent carboxyl groups and a carboxylated acrylic copolymer.

20. The method of claim 19, wherein said water-borne polycarbonate urethane is present in an amount of from about 5 to about 95 parts by weight, and said acrylic copolymer is present in an amount of from about 95 parts to about 5 parts by weight.

21. The method of claim 17, wherein said step of applying a second layer includes the step of forming a polymer composition consisting essentially of a polymer selected from the group consisting of fluoropolymer textile treating agents.

22. The method of claim 21, wherein said fluoropolymer textile treating agents are selected from the group consisting of perfluorocarbon moeities up to four carbon atoms in length.

23. A method for producing a hydophobic, oleophobic and stain resistant fabric including the steps of
selecting a suitable fabric substrate and applying a base coating to form a scrub resistant first layer at least partially penetrating the fabric substrate;
drying and curing the scrub resistant first layer;
applying a fluoropolymer coating over the first layer to form a second layer; and
drying and curing said second layer.
